(19) United States
(12) Patent Application Publication
(10) Pub. No.: US 2025/0032330 A1
(43) Pub. Date: Jan. 30, 2025

(54) BOARDING SYSTEM FOR A VEHICLE WITH A MULTI-PART BOARDING RAMP

(71) Applicant: Bode - Die Tür GmbH, Kassel (DE)

(72) Inventor: Diako Rasekhi Coochesfahani, Kassel (DE)

(21) Appl. No.: 18/781,042

(22) Filed: Jul. 23, 2024

(30) Foreign Application Priority Data
Jul. 25, 2023 (DE) 20 2023 104 164.7

(51) Int. Cl. A61G 3/06

(52) U.S. Cl. CPC A61G 3/061

(57) ABSTRACT

A vehicle boarding system includes a cassette for accommodating and displaceably mounting a sliding step, wherein the cassette is arranged below a vehicle door opening; a sliding step configured to assume an extended or a retracted state by a displacement motion, a cover flap for closing the cassette at least at the front and for covering the sliding step in the retracted state, a tread strip that at least partially closes the cassette at the top and covers the sliding step in some areas. The boarding system includes a coupling element which mechanically couples the tread strip, cover flap, and sliding step to one another. The coupling element is arranged such that, in an at least partially extended state of the sliding step, the tread strip, cover flap, and at least a part of the sliding step form a boarding ramp for facilitating the boarding of persons into the vehicle.

### CROSS-REFERENCE TO RELATED APPLICATIONS

This application claims the benefit of German patent application 20 2023 104 164.7, filed on 25 Jul. 2023, the disclosure of which is incorporated herein by reference in its entirety.

### TECHNICAL FIELD

The present disclosure relates to a boarding system for a vehicle, in particular for a public transport vehicle, comprising a cassette for accommodating and displaceably mounting a sliding step which is configured to extend laterally out of the vehicle. To form a boarding ramp, the boarding system also comprises a tread strip and a cover flap which closes the side of the cassette when not in use.

### BACKGROUND

Boarding systems are used to make it easier for people to get on and off a vehicle. In the meaning of the disclosure, a public transport vehicle can be, for example, a rail vehicle such as a train, a streetcar, a tram, a subway, etc. Such a vehicle can also be a wheeled vehicle such as a bus. Boarding systems often facilitate boarding and alighting by reducing the gap between a platform or stop and the vehicle and/or compensating for a height difference between the vehicle and the platform. Boarding systems can be designed in the form of sliding step systems or folding step systems, for example. Combined systems are also known. In the present case, particular reference is made to sliding step systems.

The installation space available for a boarding system can vary depending on the vehicle type, vehicle size or customer requirements. Accordingly, there is an increased need for simple and flexible adaptation of boarding systems to the installation space available in a vehicle. Usually, the boarding system is located in a relatively flat installation space below the door opening of the vehicle. Within this flat installation space, a boarding ramp must be provided that bridges the gap between the vehicle door opening and a stop (e.g., a platform). Ideally, a horizontal distance as large as possible between the door opening and the stop, as well as a height difference as large as possible from the lower edge of the door opening to the stop can be bridged. Conventional boarding systems have steep angles of the boarding ramp or have to use steps to bridge larger gaps. However, a steep boarding ramp or steps are perceived as disadvantageous by passengers and cannot be negotiated by wheelchair users or people with walking aids.

### SUMMARY

The disclosure provides an improved boarding system which does not have the disadvantages of the prior art.

This advantage is achieved by providing the devices of the independent claims.

The boarding system according to the disclosure is suitable for a vehicle, and in particular for a public transport vehicle. Preferably, the vehicle is a rail vehicle or a bus.

The boarding system comprises a cassette for accommodating a sliding step and for the displaceable mounting of such a step, wherein the cassette is configured to be arranged below a door opening of the vehicle. The boarding system further comprises the sliding step which, due to its displaceable mounting in the cassette, is configured to assume an extended or retracted state by a displacement motion. The states in between are referred to as partially extended states. During displacement, the sliding step moves out of the vehicle over an outer shell of the vehicle and usually transversely to the direction of travel of the vehicle into the extended state, with the directional information referring to a cassette arranged in the vehicle as intended. The boarding system further comprises a cover flap for closing the cassette on at least one side and for covering the sliding step in a retracted state, and a tread strip which at least partially closes the cassette at the top. The boarding system is characterized in that it comprises a coupling element which mechanically couples the tread strip, the cover flap, and the sliding step to one another. The coupling element is configured in such a manner that, in an at least partially extended state of the sliding step, the tread strip, the cover flap and at least part of the sliding step form a boarding ramp for facilitating the boarding of persons into the vehicle.

The cassette can be designed in the form of a cassette frame, i.e., it does not have to be completely closed. The cassette can have a U-shape or C-shape, for example.

The shape of the cassette or the cassette frame is adapted to the shape of a cassette holder. The cassette holder can be a recess on the vehicle in which the cassette can be fully accommodated. However, it is also conceivable that the cassette holder itself already represents the cassette, i.e., the cassette is already part of the vehicle. For example, the cassette holder can be arranged below a door opening and below the vehicle floor (this refers to the floor inside the vehicle that is walked on by people in the vehicle). A vehicle-side fastening element, for example a frame element, is arranged in the cassette holder, to which the cassette can be fastened.

The cassette is configured to accommodate a sliding step. The sliding step is displaceably mounted in the cassette. The sliding step can be extended sideways out of the vehicle due to the displaceable mounting. In doing so, the sliding step moves at least partially over an outer shell of the vehicle, also referred to as the vehicle contour or outer contour, so that the sliding step protrudes from the vehicle in an extended state. The retracted state is the position of the sliding step in which the sliding step is fully retracted into the cassette. This means that the sliding step does not protrude beyond the outer shell of the vehicle in this state.

The sliding step preferably moves horizontally and transversely to the direction of travel. Inclination or raising or lowering of the sliding step is preferably not provided. The sliding step or the boarding system can extend completely and, for example, bridge or close a gap between the platform and the train before the door of the vehicle is opened. This provides additional safety for passengers.

The cover flap is configured to close the side of the cassette when the sliding step is retracted. The cassette and the vehicle are designed to be open below the door opening so that, among other things, the sliding step can be extended. This lateral opening in the vehicle and in the cassette can be closed with the cover flap, for example to prevent dirt and water from entering.

The tread strip closes the cassette at least partially at the top. The tread strip forms part of the floor of the vehicle and is adjacent to the door opening. Since the cassette is arranged below the floor, the tread strip closes the cassette at the top in this region. The part of the top of the cassette that is not covered by the tread strip is usually covered by other floor elements of the floor that are not part of the boarding system.

The sliding step, the cover flap and the tread strip extend substantially across the entire width of the door opening.

The sliding step, the cover flap and the tread strip are mechanically coupled to each other via a coupling element. As a result, the tread strip and the cover flap are positively guided by the movement of the sliding step. The coupling element comprises three coupling points, one to the sliding step, one to the cover flap and one to the tread strip, via which the coupling element is pivotably connected to the respective components. The coupling points cannot move relative to each other and are rigidly arranged on the coupling element. The coupling element can form, for example, two lever arms starting from the coupling point for the sliding step, wherein the coupling point to the tread strip is arranged at one end of the first lever arm and the coupling point to the cover flap is arranged at one end of the second lever arm. The lengths of the lever arms or the distances between the coupling points can be selected depending on the desired movement of the tread strip and the cover flap.

The dimensions of the coupling element are such that in the extended state of the sliding step, the tread strip, the cover flap and at least part of the sliding step together form a boarding ramp. The boarding ramp assembled in this manner has few or no tripping hazards, i.e., protruding edges, components with acute angles to each other, steps, or the like. The boarding ramp therefore forms a substantially continuous surface on the upper side of the boarding ramp, which can be easily walked on by people when boarding.

The joint use of the tread strip for the boarding ramp has the advantage that the boarding ramp already begins to a certain extent inside the vehicle shell since the tread strip is also part of the boarding ramp. Furthermore, the cover flap is also used for the boarding ramp, so that the sliding step is no longer the only part of the boarding ramp, but the boarding ramp or the tread surface of the boarding ramp is now formed from the three components mentioned.

This design essentially offers two options. In one variant, the sliding step can be shorter since the tread strip and the cover flap form part of the boarding ramp. The shorter sliding step makes it possible to save installation space, material, and weight. The travel distance of the sliding step is also shorter in this case. Due to shorter travel distances and the shorter sliding step, the lever arms or lever ratios can be shortened so that lower forces act on the boarding system when people are boarding and alighting.

In another variant, the sliding step is not made shorter, but has a conventional length so that the boarding ramp is extended by the tread strip and the cover flap. In this manner, the angle of inclination of the boarding ramp can be kept smaller to bridge a certain height difference, or a greater height difference can be bridged with the same angle of inclination.

Of course, variants in between can also be selected, which combine the advantages of both of the aforementioned variants.

The angle of inclination and the evenness of the boarding ramp are preferably based on the ADA compliance guidelines, which enable people in wheelchairs, for example, to get into the vehicle without any problems. Preferably, the boarding ramp is based on the EN 14752 guideline. Accordingly, the boarding ramps are to be designed and evaluated for a range of use (length) that is determined by the vertical gap that can be bridged at a maximum inclination of 18% (10.2 degrees). The evaluation of the operating range of the ramp must be derived from the maximum permissible angle and the resulting ramp length to the height of the platform at which the train is to stop.

Since the sliding step, the cover flap, and the tread strip as part of the boarding ramp are walked or driven on by people, wheelchairs, bicycles, etc., these components and their attachments to the cassette or vehicle must be designed in a correspondingly stable and, in particular, tread-resistant manner.

Depending on the door arrangement used in the vehicle, an important point can be that the coupling element is configured in such a manner that the tread strip is in its highest position when the sliding step is retracted. The tread strip must therefore not move upwards beyond this highest position while the sliding step is extending since the door leaves may be located above the tread strip. The tread strip therefore only moves downwards while the sliding step is extending, and in particular in the region of the door opening.

The tread strip preferably comprises a sealing surface that can be used to seal a contact area to the door leaves of the vehicle. This prevents water or dirt from entering the vehicle via the tread strip.

Further advantageous embodiments of the disclosure are presented in the subclaims and in the following description of the features specified in the subclaims.

The tread surface of the boarding ramp is arranged on the upper side so that persons boarding can step onto this tread surface. The tread surface is thus formed from the surfaces of the tread strip, cover flap and at least part of a surface of the sliding step.

Depending on the extended state of the sliding step, only part of the upper side of the sliding step serves to form the tread surface of the boarding ramp. Depending on the conditions of the vehicle and the stop, it can happen that the sliding step cannot or must not be fully extended into the extended state, for example because the platform is closer than usual to the vehicle. In this case in particular, only part of the surface of the sliding step is used to form the tread surface.

The tread surface is therefore composed of three surfaces, the adjacent surfaces of which in particular form an angle of less than 20°, preferably less than 10°, to each other in the extended state of the sliding step.

In a simple case, the surfaces are planes that can assume the aforementioned angles relative to one another. In reality, however, the surfaces can be curved or consist of several planes with different angles to each other. In such a case, the various planes of a component can be geometrically averaged to determine the surface in question so that, accordingly, this averaged plane assumes the angle to the adjacent surface instead of the surface in question of the component.

It is also conceivable that the angles are used with the aid of planes tangentially resting against the components and adjoining the interfaces in order to determine the angular relationship of adjacent surfaces.

Therefore, as an alternative to the surface, the features can also be related to specific planes of the individual components, wherein such a specific plane of the tread strip extends, for example, through the first and second pivot axes defined further below. Such a specific plane of the cover flap can extend through the second pivot axis and, furthermore, through a geometric center of the cover flap. Such a specific plane of the sliding step can extend through a geometric center of the sliding step and is arranged horizontally in the retracted state of the sliding step and thus oriented relative to the sliding step.

In particular, the surface of the tread strip assumes an angle of less than 20° or less than 10° to a horizontal floor of the vehicle adjoining the tread strip in an extended state of the sliding step, while the surface of the tread strip is arranged horizontally in a retracted state of the sliding step.

It is possible that the surface or the outer surface of the cover flap is adapted to the outer shell of the vehicle, thus, has a curved surface, for example, as described above. In this case, instead of the surface of the cover flap, an averaged plane of the cover flap can be determined, to which the above-mentioned angular relationships to the other surfaces can be maintained. Such an averaged plane can run, for example, through the geometric center of the cover flap and be averaged over the volume of the cover flap so that there is approximately the same volume on both sides of the plane.

In a further embodiment of the boarding system, the surfaces of the tread strip, the cover flap and the sliding step together assume an angle of less than 20°, in particular less than 10°, to a horizontal plane in the extended state of the sliding step. In this manner, tripping hazards are prevented and a boarding ramp with a low incline is achieved.

The tread strip is pivotably connected to the cassette via a first boarding ramp pivot axis arranged stationarily on the cassette. The tread strip can therefore rotate about the first boarding ramp pivot axis, whereby the pivoting is determined by the coupling element. If the coupling element moves, the tread strip can only rotate about the first boarding ramp pivot axis.

The cover flap is pivotably connected to the tread strip via a second boarding ramp pivot axis arranged stationarily on the tread strip. The cover flap can therefore rotate relative to the tread strip about the second boarding ramp pivot axis. The pivoting of the cover flap depends on the movement of the coupling element and the tread strip.

The coupling element is pivotably connected to the tread strip via a first coupling pivot axis arranged stationarily on the tread strip. The coupling element is also pivotably connected to the cover flap via a second coupling pivot axis arranged stationarily on the cover flap. The coupling element is mounted on the sliding step so as to be displaceable and pivotable about a third coupling pivot axis that is displaceably arranged on the sliding step. The coupling element preferably connects the components tread strip, cover flap and sliding step in such a manner that the movements of the components are determined and the components can only move as a function of the movement of the coupling element. The coupling element, in turn, is moved when the sliding step is extended and can rotate about the third coupling pivot axis while the coupling element is additionally positively guided relative to the sliding step and also relative to the surroundings while the sliding step is extending.

The swivel axes (first and second boarding ramp swivel axes, first, second and third coupling swivel axes) are all aligned parallel to the direction of travel of the vehicle in the case of a side door.

The coupling element is preferably configured in such a manner that when the sliding step is extending, the tread strip is pivoted about the first boarding ramp pivot axis, thereby being moved from a substantially horizontal position to a slightly downwardly inclined position. In particular, the tread strip is pivoted downwards by more than 0° and less than 5° about the first boarding ramp pivot axis.

As a rule, one or more door leaves are arranged above the tread strip, so that the tread strip cannot be pivoted upwards—in such a construction, the tread strip can only be pivoted downwards.

In the substantially horizontal position of the tread strip, the tread strip forms part of the vehicle floor on which passengers can stand during the ride. This vehicle floor can be slightly inclined in the direction of the door opening, particularly in an entry and exit area. Such a slight inclination of up to 5° is still considered to be substantially horizontal in the meaning of the application.

In a particular embodiment of the boarding system, the coupling element is configured in such a manner that, when the sliding step is extended, the cover flap is pivoted about the second boarding ramp pivot axis, thereby being moved from a substantially vertical position to a substantially horizontal position. In particular, the cover flap is pivoted upwards by more than 45° and less than 120° about the second boarding ramp pivot axis. Since the cover flap can form part of the outer shell of the vehicle in the retracted state of the sliding step, or at least coincides with the outer shell of the vehicle, the cover flap is then arranged substantially vertically. Substantially vertical therefore means that not all surfaces of the cover flap have to be arranged vertically. The surfaces and in particular the outer surfaces of the cover flap can follow the outer contour of the vehicle, which in the lower area of rail vehicles, for example, can curve towards the inside of the vehicle. However, most of the surface or outer surface of the cover flap extends in particular vertically.

The kinematics or lever lengths depend on the depth of the tread strip, the height of the cover flap, and the height difference between the top edge of the floor of the vehicle and the platform.

To ensure that the tread strip and the cover flap move as desired when the sliding step is extending, the positions of the pivot axes on the tread strip, the cover flap, and the sliding step as well as the distances or lever lengths of the coupling element between the pivot axes are selected accordingly.

In a particular embodiment of the boarding system, the sliding step has a displacement contour for guiding the coupling element, which is configured to guide the third coupling pivot axis of the coupling element, which is displaceably mounted on the sliding step, along the displacement contour when the sliding step is extending. The third coupling pivot axis is guided along the sliding contour when the sliding step is extending. The third coupling pivot axis can be lifted, for example, when the sliding step is extending, while the coupling element is pivoted by the lifting. In turn, the cover flap and the tread strip can be moved by pivoting and lifting the coupling element. When retracting the sliding step, the movements take place in the opposite direction and sequence.

Such a sliding contour can be implemented, for example, with the aid of a guide rail. The coupling element is therefore guided along a guide rail on the sliding step transverse to the direction of travel of the vehicle. Preferably, the third coupling pivot axis of the coupling element is also guided in the guide rail. For this purpose, the coupling element can comprise a roller that rolls in the guide rail and/or have a sliding contact that slides in the guide rail.

To ensure that the boarding ramp consisting of the tread strip, cover flap and sliding step can be optimally formed, it has proven to be advantageous if the guide rail is arranged to slope down towards the outer shell of the vehicle and towards the cover flap. In doing so, the guide rail is arranged transversely to the direction of travel of the vehicle. When the sliding step is extending, the coupling element is lifted by the guide rail and at the same time pivoted due to the coupling to the tread strip and the cover flap.

It is possible to provide only one coupling element 30, but two coupling elements arranged to the side of the sliding step are also conceivable.

In a further embodiment of the boarding system, the guide rail has a depression arranged in such a manner that the coupling element is guided into the depression of the guide rail when the sliding step is in an extended position. Due to the depression, the coupling element is lowered a little in the extended state so that the angles of the surfaces of the tread strip and cover flap for the boarding ramp are optimized. In this embodiment, the surface of the tread strip and the cover flap is lowered a little further so that a flatter and smoother tread surface of the boarding ramp is achieved.

In a further embodiment of the boarding system, the coupling element is configured in such a manner that in the retracted state of sliding step, the cover flap is pretensioned against the cassette or against a dead stop to close the cassette. The cover flap closes the cassette on at least one side and thus protects it against penetration of dirt and/or water. To ensure that this can be done securely, it is advantageous if the cover flap is pretensioned against the cassette and in particular against a sealing arrangement between the cassette and the cover flap.

Moreover, by tensioning the cover flap, a pretensioning of the cover flap can be generated, which holds the cover flap securely in position against external influences such as air pressure fluctuations caused by airstream or mechanical loads. By pretensioning the cover flap, the tread strip is also pretensioned at the same time due to the mechanical connection to the coupling element, so that the tread strip can also be held securely in position. For example, the tread strip must be able to bear the weight of people being transported in the vehicle.

Preferably, the coupling element is therefore configured in such a manner that both the cover flap and the tread strip are pretensioned against the cassette or respective dead stops in the retracted state of the sliding step. This has the advantage that the components are securely fixed and do not move, or only move to a limited extent, even when external forces act on these components. This is the case, for example, when people step on the tread strip during the ride, or if aerodynamic forces act on the cover flap from the outside.

Since the tread strip forms part of the floor of the vehicle, in a further embodiment of the access system, the coupling element is configured in such a manner that the tread strip is fixed in a substantially horizontal position (as defined above) in the retracted state of the sliding step.

In a further embodiment of the access system, the cover flap comprises a roller, wherein the roller rolls transverse to the direction of travel of the vehicle on a surface of the sliding step when the sliding step is extending and retracting. Rolling the roller of the cover flap on the surface of the sliding step ensures, on the one hand, that there is no gap between the cover flap and the sliding step and, on the other hand, a further guide is provided for the coupling element so that the coupling element is guided as desired.

The roller of the cover flap can also roll in a further guide rail of the sliding step, and a sliding contact or the like can be provided instead of a roller.

The disclosure also relates to a door system with a boarding system as described above. For this purpose, the door system also comprises, for example, in addition to one or more door leaves which can be used to close a door opening in the vehicle, a boarding system according to the disclosure.

The disclosure also relates to a vehicle, and in particular to a rail vehicle, with a door system as described above.

### BRIEF DESCRIPTION OF THE DRAWINGS

The present disclosure is explained in detail below by means of exemplary embodiments with reference to the attached figures. In the figures:

FIG. 1 shows a boarding system from the prior art,

FIG. 2 shows a boarding system comprising a tread strip, a cover flap, and a sliding step, connected via a coupling element, and

FIGS. 3a-3e show the boarding system from FIG. 2 in various states when extending.

### DETAILED DESCRIPTION OF THE DRAWINGS

In the figures, unless otherwise indicated, identical reference signs denote identical or corresponding components with the same function.

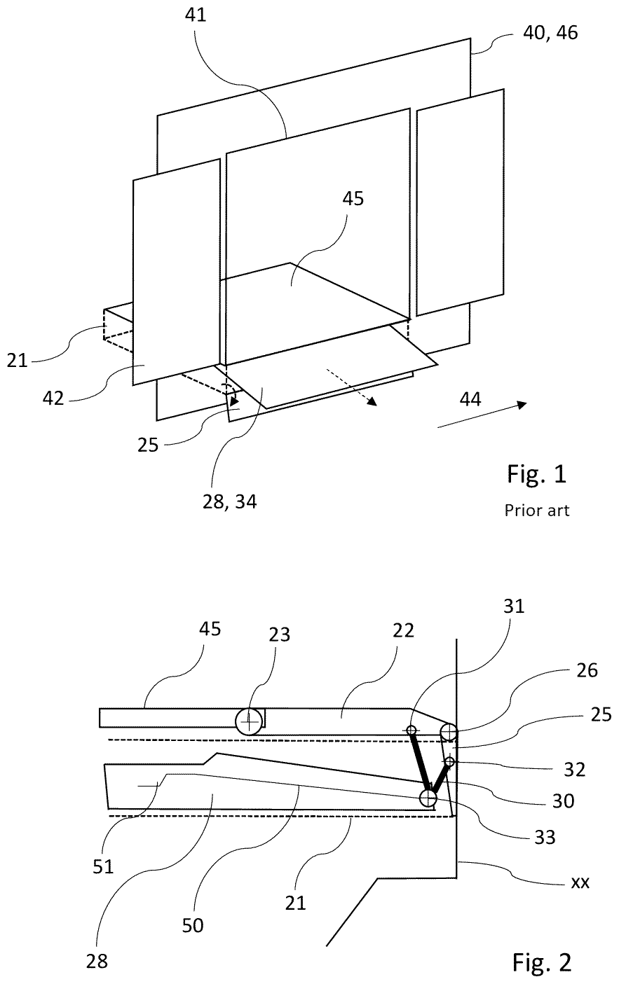

FIG. 1 shows a boarding system from the prior art. The boarding system comprises a cassette 21 arranged below a door opening 41 of a vehicle 40. At the same time, the cassette 21 is arranged below a floor 45 of the vehicle 40, on which passengers of the vehicle 40 can stand during transportation. In this case, the vehicle 40 is a rail vehicle for transporting passengers. To close the door opening 41, the vehicle 40 comprises two door leaves 42 which are laterally displaced or pivoted in order to release the door opening 41.

A one-piece boarding ramp 34 in the form of a sliding step 28 is slidably mounted in the cassette 21. To allow the sliding step 28 to extend, a cover flap 25 must be opened so that a lateral opening in the cassette 21 is released. The sliding step 28 can then extend transversely to a direction of travel 44 of the vehicle 40 beyond an outer shell 46 of the vehicle 40 and bridge a gap between the vehicle 40 and the platform 47, so that passengers can safely enter and exit the vehicle 40.

FIG. 2 shows a boarding system according to the disclosure in a retracted state of the sliding step 28. In an extended state of the sliding step 28, the boarding ramp 34 is formed by a tread strip 22, a cover flap 25 and the sliding step 28. The tread strip 22 is coupled to the floor 45 of the vehicle 40 via a first boarding ramp pivot axis 23. The cover flap 25 is pivotably attached to the tread strip 22 via a second boarding ramp pivot axle 26. The tread strip 22, the cover flap 25 and the sliding step 28 are connected to one another via a coupling element 30 via a first, second and third coupling pivot axis 31, 32 and 33.

The cover flap 25 coincides with an outer shell 46 of the vehicle 40 when the sliding step 28 is in a retracted state, as in FIG. 2. The cover flap 25 thus forms part of the outer shell 46 or the outer body of the vehicle 40 and at the same time closes the cassette 21 on one side.

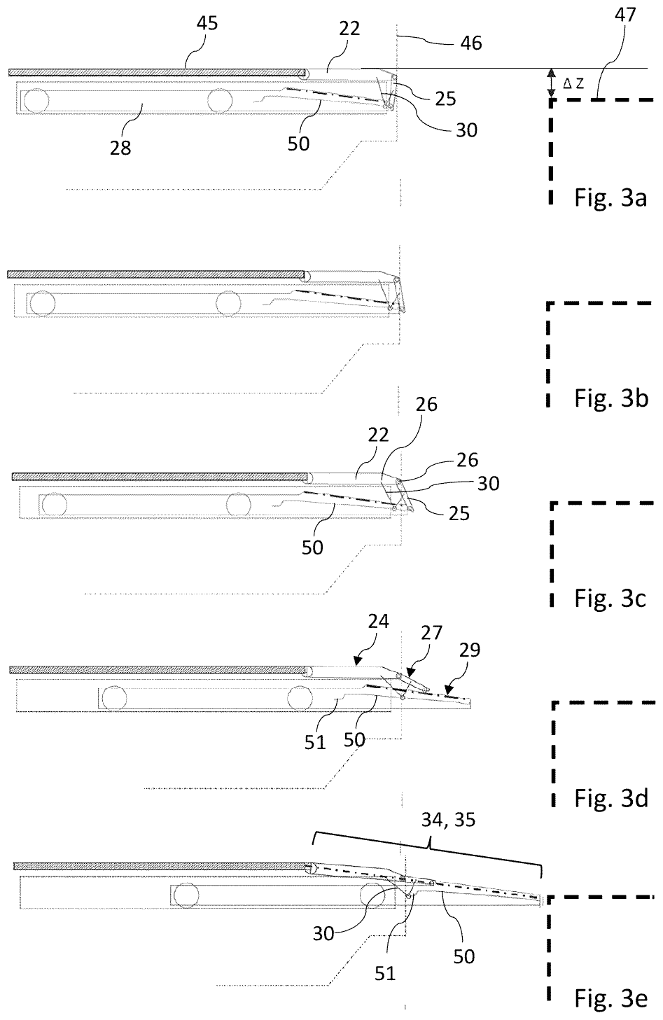

The coupling element 30 is mounted on the sliding step 28 to be slidable along a guide rail 50, whereby the coupling element 30 can also rotate relative to the sliding step 28 about the third coupling pivot axis 33. When the sliding step 28 is extended, which corresponds to the direction to the right in FIG. 2, the cover flap 25 first opens and the coupling element 30 begins to pivot counterclockwise as well as to rise upwards on the guide rail 50. This extending process is illustrated in FIGS. 3a to 3e with the aid of several intermediate steps.

FIGS. 3a to 3e show the boarding system according to the disclosure of FIG. 2 in various states during the extending of the sliding step 28. For the sake of clarity, not all components have been provided with the reference signs used in the application, but only those which are used in the figure description of FIGS. 3a to 3e.

FIG. 3a shows the sliding step 28 in a fully retracted state. The tread strip 22 is in a horizontal position, while the cover flap 25 is in a nearly vertical position and substantially coincides with the outer shell 46 of the vehicle 40. The coupling element 30 is located at the front end of the guide rail 50. The floor 45 is located Δz higher than the platform 47 and there is a gap between the vehicle 40 and the platform 47, which has to be bridged by the boarding system or the boarding ramp 34.

In FIGS. 3b and 3c, the sliding step 28 slowly moves beyond the outer shell 46 of the vehicle 40 while the cover flap 25 gradually opens by pivoting about the second boarding ramp pivot axis 26. In doing so, the cover flap 25 rolls at its lower end over a roller on the sliding step 28 and is thus pivoted or opened counterclockwise by the sliding step 28.

Meanwhile, the tread strip 22 remains horizontal and does not rise, although the coupling element 30 is displaced upwards by the displacement along the guide rail 50; however, the coupling element 30 is simultaneously pivoted counterclockwise, so that the height of the first coupling pivot axis 32 remains almost constant, so that the tread strip 22 is also not moved.

In FIG. 3d, the boarding ramp 34 is basically already operational but not yet fully extended. The boarding ramp 34 is formed from a surface 24 of the tread strip 22, a surface 27 of the cover flap 25 and a part of the surface 29 of the sliding step 28. The surfaces 24, 27 and 29 are at slight angles to each other, so that a tread surface 35 of the boarding ramp 34 is formed as straight and flat as possible. However, the gap between the vehicle 40 and the platform 47 is not yet sufficiently bridged, so that the sliding step 28 extends further.

In FIG. 3e, the sliding step 28 is fully extended, so that the boarding ramp 34 is also fully formed. The last small gap between boarding ramp 34 and platform 47 is so small that it no longer poses a problem for people boarding and alighting, so that this gap can remain. Due to the fully extended sliding step 28, the angles between the surfaces 24, 27 and 29 are particularly small, so that the tread surface 35 is particularly flat. This is given in particular by the fact that the coupling element 30 is inserted into a depression 51 at the left end of the guide rail 50, so that both the tread strip 22 and the cover flap 25 have been moved downwards a little in comparison to FIG. 3d and thus have been brought to each other at a flatter angle. In addition, the upper surface 29 of the sliding step 28 is provided with a depression 52 into which the roller of the cover flap 25 or the cover flap 25 itself can retract, so that the difference in height between the surface 27 of the cover flap 25 and the surface 29 of the sliding step 28 can also be at least partially compensated for.

With such a structure, the boarding ramp 34 can therefore already start very far to the left, i.e., inside the vehicle 40, can use the already existing cover flap 25, and can thus form a long or flat tread surface 35.

1. A boarding system for a vehicle comprising:
a cassette for accommodating and displaceably mounting a sliding step, wherein the cassette is configured to be arranged below a door opening of the vehicle,
a sliding step which is configured to assume an extended or a retracted state by a displacement motion,
a cover flap for closing the cassette at least at the front and for covering the sliding step in the retracted state,
a tread strip which at least partially closes the cassette at the top and covers the sliding step in some areas,
wherein,
the boarding system comprises a coupling element which mechanically couples the tread strip, the cover flap and the sliding step to one another, and
the coupling element is arranged such that, in an at least partially extended state of the sliding step, the tread strip, the cover flap and at least a part of the sliding step form a boarding ramp for facilitating the boarding of persons into the vehicle.

2. The boarding system according to claim 1,
wherein in the extended state of the sliding step, adjacent surfaces assume in each case an angle of less than 20° to one another.

3. The boarding system according to claim 1,
wherein the surfaces assume an angle of less than 20° to a horizontal plane in the extended state of the sliding step.

4. The boarding system according to claim 1,
wherein the tread strip is pivotably connected to the cassette via a first boarding ramp pivot axis arranged stationarily on the cassette.

5. The boarding system according to claim 1,
wherein the cover flap is pivotably connected to the tread strip via a second boarding ramp pivot axis arranged stationarily on the tread strip.

6. The boarding system according to claim 1,
wherein the coupling element is pivotably connected to the tread strip via a first coupling pivot axis arranged stationarily on the tread strip, and the coupling element is pivotably connected to the cover flap via a second coupling pivot axis arranged stationarily on the cover flap, and the coupling element is mounted on the sliding step so as to be displaceable and pivotable about a third coupling pivot axis arranged displaceably on the sliding step.

7. The boarding system according to claim 6,
wherein the coupling element is configured such that when the sliding step is extending, the tread strip is pivoted about the first boarding ramp pivot axis and is thereby brought from a substantially horizontal position into an inclined position, wherein the tread strip is pivoted by more than 0° and less than 5° about the first boarding ramp pivot axis downwards in the direction of the ground.

8. The boarding system according to claim 1,
wherein the coupling element is configured such that when the sliding step is extending, the cover flap is pivoted about the second boarding ramp pivot axis, and is thereby brought from a substantially vertical position into a substantially horizontal position, wherein the cover flap is thereby pivoted upwards by more than 45° and less than 120° about the second boarding ramp pivot axis.

9. The boarding system according to claim 1,
wherein the sliding step has a displacement contour which is configured to guide the third coupling pivot axis of the coupling element, which is displaceably mounted on the sliding step, along the displacement contour when the sliding step is extending.

10. The boarding system according to claim 1,
wherein the coupling element is guided along a guide rail on the sliding step transversely to the direction of travel of the vehicle, wherein the third coupling pivot axis of the coupling element is guided accordingly.

11. The boarding system according to claim 10,
wherein the guide rail is arranged sloping downwards in the direction of the outer shell of the vehicle and in the direction of the cover flap.

12. The boarding system according to claim 1,
wherein the guide rail has a depression which is arranged such that in an extended position of the sliding step, the coupling element is guided into the depression of the guide rail.

13. The boarding system according to claim 1,
wherein the coupling element is configured such that in the retracted state of the sliding step, the cover flap is pretensioned against the cassette or a dead stop for closing the cassette.

14. The boarding system according to claim 1,
wherein the coupling element is configured such that in a retracted state of the sliding step, the tread strip is fixed in a horizontal position.

15. The boarding system according to claim 1,
wherein the cover flap comprises a roller, wherein the roller rolls transverse to the direction of travel of the vehicle on a surface of the sliding step when the sliding step is extending and retracting.

16. A door system with boarding system according to claim 1.

17. A vehicle with a door system according to claim 16.
